(19) United States
(12) Patent Application Publication
(10) Pub. No.: US 2011/0088068 A1
(43) Pub. Date: Apr. 14, 2011

(54) LIVE MEDIA STREAM SELECTION ON A MOBILE DEVICE

(75) Inventors: Christopher Patnoe, Palo Alto, CA (US); Steve Colen, II, San Rafael, CA (US)

(73) Assignee: SONY ERICSSON MOBILE COMMUNICATIONS AB, Lund (SE)

(21) Appl. No.: 12/617,112

(22) Filed: Nov. 12, 2009

Related U.S. Application Data
(60) Provisional application No. 61/250,213, filed on Oct. 9, 2009.

(51) Int. Cl. H04N 5/445; G06F 15/16

(52) U.S. Cl. 725/61; 709/229; 709/231; 715/764; 709/227

(57) ABSTRACT

A method may include establishing, via a mobile device, a plurality of media streaming sessions with a respective plurality of source devices. A plurality of media streams may be received at the mobile device from respective plurality of source devices. Representations of the plurality of received media streams may be displayed at the mobile device. A user selection of a particular one of the plurality of received media streams may be received. An output stream that includes the particular one of the plurality of received media streams may be outputted.

### CROSS-REFERENCE TO RELATED APPLICATIONS

This application claims priority under 35. U.S.C. §119, based on U.S. Provisional Patent Application No. 61/250,213 filed Oct. 9, 2008, the disclosure of which is hereby incorporated by reference herein.

### BACKGROUND

Many of today's portable electronic devices, such as mobile telephones, portable media players, camcorders, digital cameras, etc., have the ability to record media, such as audio and video. The recorded media may be stored on a storage device, such as a hard drive, or transmitted to another device via a cable or network.

### SUMMARY

According to one aspect, a method may include establishing, via a mobile device, a plurality of media streaming sessions with a respective plurality of source devices; receiving, at the mobile device, a plurality of media streams from respective plurality of source devices; displaying representations of the plurality of received media streams; receiving a user selection of a particular one of the plurality of received media streams; and outputting an output stream that includes the particular one of the plurality of received media streams.

Additionally, the plurality of source devices may comprise mobile devices.

Additionally, the plurality of media streams and the output stream may comprise substantially real time streams.

Additionally, establishing the plurality of media streaming sessions may further include outputting a host identifier associated with the mobile device on a network connected to the source devices.

Additionally, the network may comprise a wireless local area network (WLAN), an ad-hoc wireless network, or a cellular telecommunications network.

Additionally, the method may further include receiving a request to establish the streaming sessions from each of the plurality of source devices based on the host identifier.

Additionally, establishing the plurality of media streaming sessions may further include transmitting, to each of the plurality of source devices, information relating to the streaming sessions, wherein the information comprises addressing information.

Additionally, establishing the plurality of media streaming sessions may further include authenticating the plurality of source devices.

Additionally, the method may further include receiving, at the mobile device, a user selection of a destination for the output stream; and outputting the output stream to the selected destination.

Additionally, the destination may comprise an external display, a storage device, or a network device associated with a media streaming service.

Additionally, the external display may comprise a television or video projector.

Additionally, the method may further include receiving a user selection of another particular one of the plurality of received media streams; modifying the output stream to include the another particular one of the plurality of received media streams; and outputting the modified output stream that includes the another particular one of the plurality of received media streams.

According to another embodiment, a mobile device may include a network interface to receive a plurality of video streams from a respective plurality of source devices; a display; an output interface; and a processor. The processor may be configured to establish a plurality of video streaming sessions with the respective plurality of source devices for enabling the network interface to receive the plurality of video streams; display representations of the plurality of received video streams on the display; receive a user selection of a particular one of the plurality of received video streams; and output an output stream via the output interface, wherein the output stream includes the particular one of the plurality of received media streams.

Additionally, the plurality of video streaming sessions may comprise substantially real time streaming sessions for receiving substantially real time video streams from the plurality of source devices via the network interface.

Additionally, the processor may be further configured to output a host identifier associated with the mobile device to the plurality of source devices via the network interface.

Additionally, the host identifier may be output via a zero-configuration protocol.

Additionally, the network interface may be configured to receive the plurality of video streams via a wireless local area network (WLAN), an ad-hoc wireless network, or a cellular telecommunications network.

Additionally, the processor may be further configured to receive a user selection of a destination for the output stream; and output the output stream to the selected destination via the output interface.

According to yet another aspect, a computer-readable medium having stored thereon a plurality of sequences of instructions is provided, which, when executed by at least one processor, cause the at least one processor to receive a plurality of substantially real time media streams from a respective plurality of source devices; display, to a user, representations of the plurality of received substantially real time media streams; receive, from the user, a selection of a particular one of the plurality of received substantially real time media streams; and output an output stream that includes the particular one of the plurality of received media streams.

Additionally, the plurality of sequences of instructions may further cause the at least one processor to output the output stream to an external display device that includes a television, or a projector.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 illustrates concepts described herein;

FIG. 2 is a diagram of an exemplary network in which the concepts described herein may be implemented;

FIGS. 3A and 3B are front and rear views, respectively, of an exemplary device in which concepts described herein may be implemented;

FIG. 4 is a block diagram of exemplary components of the exemplary device of FIGS. 2, 3A, and 3B;

FIG. 5 is a functional block diagram of an exemplary host device of FIG. 2;

FIGS. 6A and 6B are diagrams of exemplary user interfaces associated with the host device of FIG. 5;

FIG. 7 is a functional block diagram of an exemplary source device of FIG. 2; and

FIG. 8 is a flow diagram of an exemplary process for enabling live media stream selection on a mobile device.

### DETAILED DESCRIPTION OF EMBODIMENTS

The following detailed description refers to the accompanying drawings. The same reference numbers in different drawings may identify the same or similar elements.

Systems and methods described herein may facilitate dynamic production of mobile real time media streams. For example, a host device may receive multiple real time media streams from a number of source devices. A user of the host device may dynamically select from the available media streams and may broadcast or output a media stream that includes the selected stream. The user's choice of included stream may be modified or updated at any time, thereby enabling the user of the host device to create more engaging content.

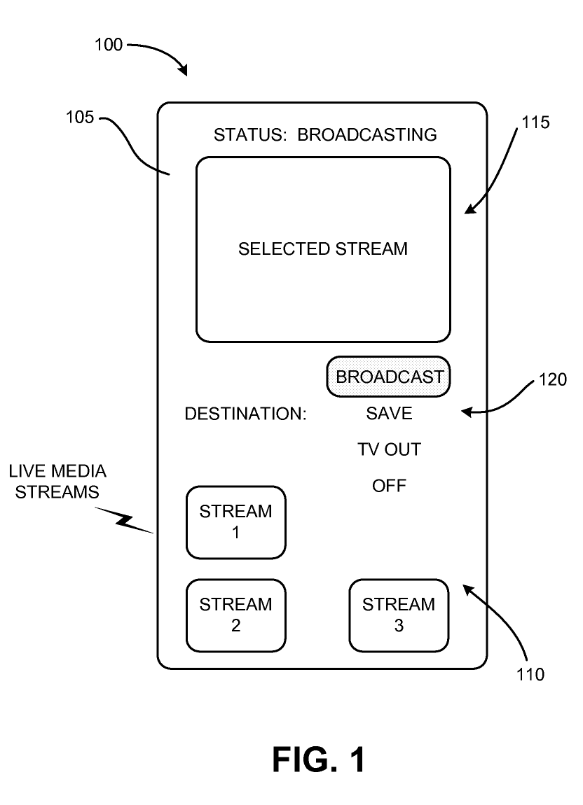

FIG. 1 illustrates an example of the above-described concept. As illustrated in FIG. 1, a user device 100 may be configured to simultaneously receive live media streams from a number of other user devices (not shown). Assume for the purposes of this example that the live media streams relate to an ongoing news event, such as a political rally, a sporting event, or a party or other social event. As depicted in FIG. 1, the live media streams may be received wirelessly via a direct wireless connection with user device 100 or via a wireless network, such as a wireless local area network (WLAN) or wireless telecommunications (e.g., cellular) network.

User device 100 may include a mobile communications device configured to include an application or logic to allow users to preview and select one of the received live media streams. The selected media stream may then be broadcast (or re-broadcast), saved, or output to an external display device, such as a television, video projector, audio system, home theater PC, etc. The user may change the selected media stream at any time from among a number of available media streams, effectively enabling the user to act as a producer of the final media stream, making selections relating to the particular media streams being used, the duration of their use, the output of the resulting stream, etc.

As shown in FIG. 1, user device 100 may include a display 105 having a user interface that includes a media preview/selection area 110, a selected media stream area 115, and a stream destination area 120. As will be described in additional detail below, media preview/selection area 110 may display representations associated with each received live media stream. Exemplary representations may include still images, low-resolution videos, user identifications (e.g., text, icons, etc.) associated with the device from which the streams are received, etc. A user of user device 100 may select one of the available media streams as the currently selected stream. Upon selection, the received media stream may be presented in selected media stream area 115. For example, if the media stream is a live video stream, the video stream may be displayed in selected media stream area 115.

Stream destination area 120 may be configured to receive a user selection of an output destination for the selected stream. In one exemplary embodiment, available output destinations may include a live broadcast, e.g., via an upload to a network device associated with a media streaming service, such as uStream.tv or justin.tv; a storage medium, such as a flash memory or hard disk drive; or a display device, such as a television, video projector, audio system, etc.

By enabling a mobile device (e.g., device 100) to receive multiple live media streams and selectively output the streams in a desired manner, the system described herein provides users with an ability to interactively produce an output media stream. The term “media stream,” as used herein, may refer to any audio-visual information received or transmitted via a streaming protocol, such as real time streaming protocol (RTSP).

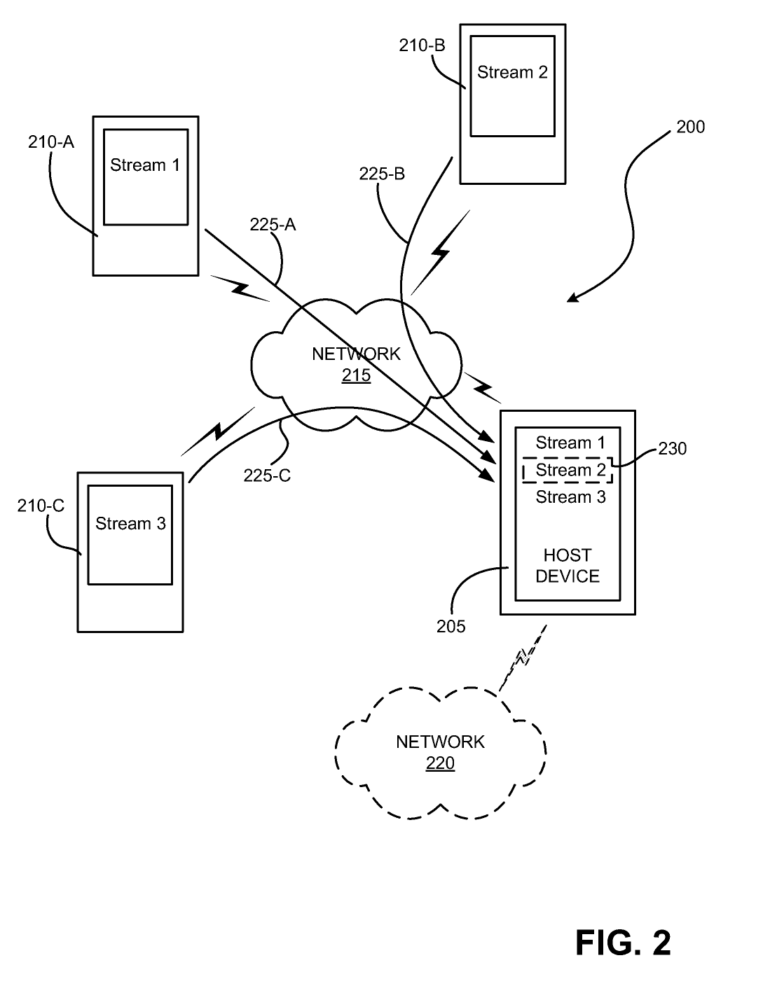

FIG. 2 is a diagram of an exemplary network 200 in which the concepts described herein may be implemented. As illustrated, network 200 may include a host device 205, a number of source devices 210-A, 210-B, and 210-C (collectively, “source devices 210” and individually, “source device 210”), network 215, and, optionally, network 220. Although not shown, network 200 may include other devices, such as wireless access points (WAPs), routers, switches, etc. Further, depending on the implementation, network 200 may include additional, fewer, or different devices than the ones illustrated in FIG. 2. For example, in some implementations, network 200 may include many more user devices 210.

Each source device 210 may be configured, as described in additional detail below, to capture a media stream, such as a video stream via a camera associated with the device. Further, each source device 210 may be configured to include logic, such as a software or hardware application that enables each source device 210 to identify and transmit a media stream to host device 205. For example, a dedicated application or plug-in to an existing camera or video capture application may enable each source device 210 to identify host device 205 via network 215. The application may then establish a connection or session between source device 210 and host device 205 via network 215. The established sessions are represented in FIG. 2 by arrows 225-A, 225-B, and 225-C (collectively, “sessions 225” and individually, “session 225”). In some implementations, network 215 may include a short-range wireless network, such as a WLAN, Bluetooth® network or other personal area network (PAN), an ad-hoc wireless network established by host device 205, or a cellular-type wireless data network (e.g., a 3G, 4G, or long term evolution (LTE) network).

A stream of media captured at each source device 210 via its respective camera (or, in the case of audio, its microphone) may be transmitted to host device 205 via sessions 225.

Host device 205 may be configured, as described in additional detail below, to receive media streams from source devices 210 via sessions 225 established over network 215. More specifically, host device 205 may be configured to execute an application or other logic that establishes or enables sessions 225. For example, host device 205 may broadcast its service availability to applications executing on source devices 210 via a bonjour or zero-configuration mechanism. Such mechanisms may enable devices on a network to easily “view” and connect to other devices on that network that have predetermined capabilities. In other implementations, host device 205 may establish an ad-hoc wireless network, subsequently available for source devices 210 to connect to.

Once the service availability has been enabled, host device 205 may establish media streaming sessions 225 with source devices 210. In one implementation, service availability may be persistent while the application is executing, thereby enabling different source devices 210 to connect and disconnect during execution of the application. For example, a new source device 210 may enter an area covered by network 215 and may activate their stream sharing application even after other users have previously done so. In this example, new source device 210 may establish a new session 225 with host device 205 and may subsequently transmit a new video stream to host device 205.

As briefly described above in relation to FIG. 1, the application executing on host device 205 may provide a user interface than allows users to view the available streams received from source devices 210 (e.g., stream 1, stream 2, stream 3 depicted on host device 205 in FIG. 2). Host device 205 may then be configured to receive a user selection of a particular stream. This selection is represented in FIG. 2 by dashed line 230. Once selected, the selected stream is inserted into a final or “broadcast” stream compiled by host device 205. At any time, a user of host device 205 may review the available media streams and change the selected stream to a different stream. At the time of the change, the final or broadcast stream is modified to reflect the change. This configuration enables a user of host device 205 to effectively act as a producer of an output stream compiled from a number of different input streams in substantially real time.

Host device 205 may be further configured to enable a user to select an output destination for the final “broadcast” stream (although the term “broadcast” may be used herein, this term should be broadly construed to include any suitable output form, such as a file transfer, media stream, unicast data delivery, etc.). For example, host device 205 may be configured to allow the stream to be uploaded or streamed to a remote device (or devices), such as a web server or other network device associated, for example, with a media streaming service (not shown in FIG. 2) via optional network 220 shown in dashed lines in FIG. 2. Network 220 may include a fiber-optic network (e.g., passive optical networks (PONs)), a local area network (LAN), a wide area network (WAN), a wireless LAN, a metropolitan area network (MAN), a cellular network, a public switched telephone network (PSTN), an intranet, the Internet, a satellite-based network, any other network, or a combination of networks. In some implementations network 220 may include or be the same as network 215 described above.

In other implementations, host device 205 may be configured to record or store the final broadcast stream using, a storage device, such as a solid state drive, flash memory, a hard disk drive, etc. The storage device may be included as part of host device 205 or may be provided externally to host device 205, and may be connected in any suitable manner, such as via a universal serial bus (USB) connection or a wireless connection.

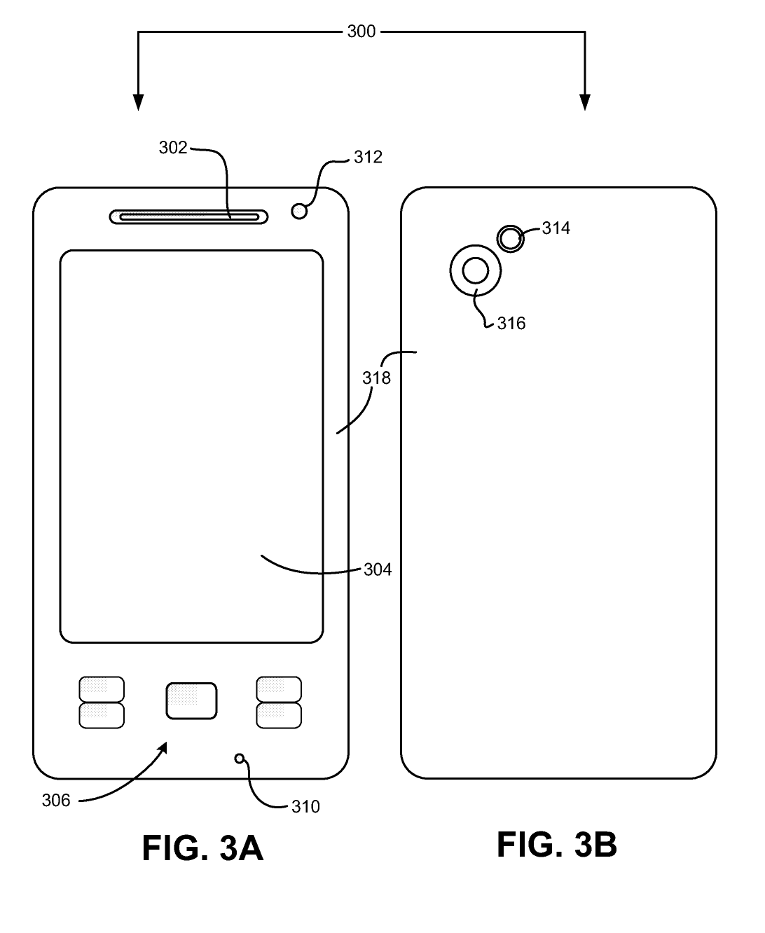

FIGS. 3A and 3B are front and rear views, respectively, of an exemplary device 300 in which concepts described herein may be implemented. Device 300 may represent host device 205 and source devices 210. In the implementation shown, device 300 may include any of the following devices that have the ability to or are adapted to capture or process media (e.g., videos, photographs, audio, etc), and connect to other devices via a network. Exemplary devices may include: a mobile telephone; a personal communications system (PCS) terminal (e.g., a smartphone) that combines a cellular radiotelephone with data processing, facsimile, and/or data communications capabilities; an electronic notepad; a laptop; a netbook; a personal computer (PC); a personal digital assistant (PDA) that can include a telephone; a video camera; a web-enabled camera or webcam; a global positioning system (GPS) navigation device; a portable gaming device; or a videoconferencing system device.

As shown, device 300 may include a speaker 302, a display 304, control buttons 306, a microphone 310, a front lens assembly 312, a light emitting diode (LED) 314, a rear lens assembly 316, and housing 318. Speaker 302 may provide audible information to a user of device 300. Display 304 may provide visual information to the user, such as video images or pictures. In one exemplary implementation, display 304 may include a touch screen display response to user contact, such as a resistive or capacitive touch screen. Control buttons 306 (along with touch screen display 304) may permit the user to interact with device 300 to cause device 300 to perform one or more operations, such as place or receive a telephone call, navigate display 304, etc.

Microphone 310 may receive audible information from the user. Front and rear lens assemblies 312/316 may include devices for manipulating light rays from a given or a selected range, so that moving and/or still images in the range can be captured in a desired manner. Front lens assembly 312 may be configured to enable device 300 to capture and image of the user. Rear lens assembly 316 may be configured to enable device 300 to capture images of subjects in front of the user. In either case, at least a portion of display 304 may be configured to display, to the user, images for capture via front and rear lens assemblies 312/316.

LED 314 may function as a flash illumination device for taking pictures or video and may also provide visual notifications to the user. Housing 318 may provide a casing for components of device 300 and may protect the components from outside elements.

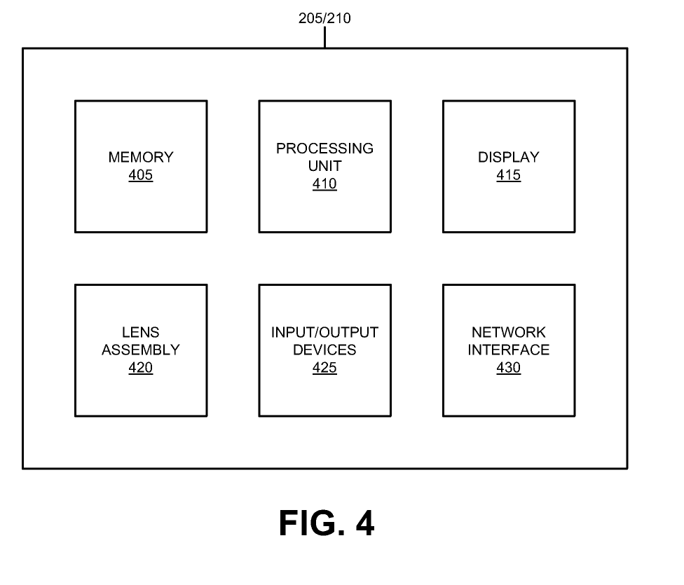

FIG. 4 is a block diagram of exemplary components of device 205/210. The term “component,” as used herein, may refer to hardware component, a software component, or a combination of the two. As shown, device 200/300 may include a memory 405, a processing unit 410, a display 415, a lens assembly 420, input/output devices 425, and a network interface 430. In other implementations, device 200/300 may include more, fewer, or different components.

Memory 405 may include static memory, such as read only memory (ROM), and/or dynamic memory, such as random access memory (RAM), or onboard cache, for storing data and machine-readable instructions. Memory 405 may also include storage devices, such as a hard disk drive, CD ROM, CD read/write (R/W) disc, and/or flash memory, as well as other types of storage devices. Processing unit 410 may include a processor, a microprocessor, an Application Specific Integrated Circuit (ASIC), a Field Programmable Gate Array (FPGA), and/or other processing logic capable of controlling device 205/210.

Display 415 may include a component that can display signals generated by device 205/210 as images on a screen and/or that can accept inputs in the form of taps or touches on the screen (e.g., a touch screen). Examples of display 415 include a liquid crystal display (LCD), organic light-emitting diode (OLED) display, surface-conduction electron-emitter display (SED), plasma display, field emission display (FED), bistable display, resistive touch screen, or capacitive touch screen.

Lens assembly 420 may include a component for manipulating light rays from a given or a selected range, so that images in the range can be captured in a desired manner (e.g., a zoom lens, a wide-angle lens, etc.). Lens assembly 420 may be controlled manually and/or electromechanically by processing unit 410 to obtain the correct focus, span, and magnification (i.e., zoom) of the subject image and to provide a proper exposure. Furthermore, lens assembly 420 may be configured to capture both still images and video images. In some implementations lens assembly 420 may include both front and rear-facing lens assemblies (e.g., lens assemblies 312 and 316).

Input/output devices 425 may include components for converting physical events or phenomena to and/or from digital signals that pertain to device 205/210. Examples of other input/output devices 425 may include a flash, button(s) (e.g., control buttons 306), mouse, speaker, microphone, Universal Serial Bus (USB) port, IEEE 1394 (e.g., Firewire®) interface, etc.

Network interface 430 may include any transceiver-like mechanism that enables device 205/210 to communicate with other devices and/or systems. For example, network interface 430 may include mechanisms for communicating via networks 215/220, such as the Internet, a WLAN, a terrestrial wireless network (e.g., a cellular-based wireless network, a satellite-based network, etc. Additionally or alternatively, network interface 430 may include a modem, an Ethernet interface to a local area network (LAN), and/or an interface/connection for connecting device 205/210 to other devices (e.g., a Bluetooth interface, near field communication (NFC) interface, a wireless USB interface, etc.).

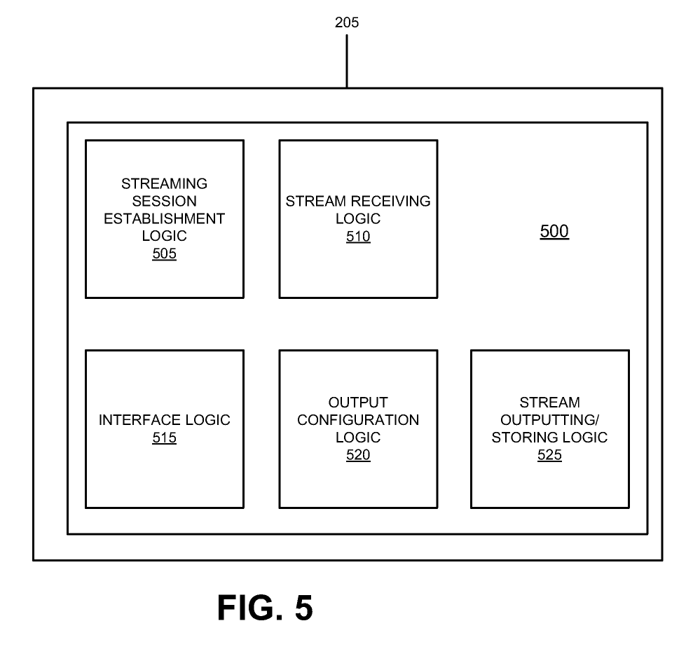

FIG. 5 is a functional block diagram of host device 205. As shown, host device 205 may include a media stream production application 500 that includes streaming session establishment logic 505, stream receiving logic 510, interface logic 515, output configuration logic 520, and stream outputting/storing logic 525. Depending on the particular implementation, host device 205 may include fewer, additional, or different types of functional blocks than those illustrated in FIG. 5. For example, host device 205 may include an operating system, a web server, etc.

Streaming session establishment logic 505 may include hardware and/or software components configured to enable establishment of streaming sessions between host device 205 and one or more source devices 210, using, e.g., network interface 430. For example, streaming session establishment logic 505 may broadcast a host identifier on a WLAN indicating that host device 205 can receive streams from source devices 210. In other implementations, such as where no WLAN previously exists, streaming session establishment logic 505 may, via network interface 430, generate an ad-hoc network (e.g., a computer to computer) that facilitates the receive of media streams from source devices 210.

In some implementations, streaming session establishment logic 505 may broadcast the host identifier using, for example, bonjour or other zero-configuration protocol. Using such a protocol, the host identifier may be easily made available to source devices looking for available host devices.

In other implementations consistent with embodiments described herein, streaming session establishment logic 505 may establish stream receiving sessions, via a LAN or WAN. For example, streaming session establishment logic 505 may configure addressing and location information with a remote support server, e.g., a proxy server, session initiation protocol (SIP) server, etc. Streaming session establishment logic 505 may transmit a message to the support server indicating its location (e.g., IP address information) and may allow the support server to broadcast the stream receiving availability of host device 205. Source devices 210 may then transmit media streams to host device by negotiating a streaming session with the support server. In some implementations, quality of service requirements may be established/enforced by the support server, to ensure that media streams having an acceptable quality are received.

In still other implementations, streaming session establishment logic 505 may be configured to support establishment of streaming sessions with source devices 210 via, e.g., a cellular communications network, such as a 3G network.

Streaming session establishment logic 505 may be further configured to receive a session request from one or more source devices 210. For example, an application executing on source devices 210 may transmit a request message to streaming session establishment logic 505. In some implementations, prior to initiating a streaming session, streaming session establishment logic 505 may determine whether each source device 210 meets predetermine quality capabilities, such as a resolution of a video camera, bandwidth capabilities, etc.

Streaming session establishment logic 505 may be configured to establish substantially real time streaming sessions with a plurality of source devices 210. As briefly described above, the substantially real time streaming sessions may be contemporaneously or non-contemporaneously established. For example, a number of sessions may be established shortly after execution of a streaming session application on host device 205 and other sessions may be established (or ended) at any time thereafter during the execution of the application.

In some implementation consistent with embodiments described herein, streaming session establishment logic 505 may support authentication between source devices 210 and host device 205. For example, users of source devices 210 may need to enter a password prior to session establishment. In other embodiments, only predetermined source device identifiers may be allowed to establish streaming sessions with host device 210.

Stream receiving logic 510 may include hardware and/or software components configured to receive real time media streams via the sessions established by streaming session establishment logic 505. For example, stream receiving logic 510 may be configured to receive third generation partnership project (3GPP)-compliant RTP media streams from source devices 210. In one implementation, the received streams may be buffered, e.g., into memory 405, for display by interface logic 515, as will be described more fully below. Upon display by interface logic 515, nonselected streams may be immediately removed from memory, thereby preserving a maximum amount of available memory for incoming media streams.

In some implementations, stream receiving logic 510 may be configured to restrict bandwidth for each streaming session prior to selection of the stream for broadcast. For example, stream receiving logic 510 may instruct source devices 210 (e.g., via a real time control protocol (RTCP) message) to drop a predetermined number of frames from their streams, effectively reducing the bit rate of the stream. Upon selection of a particular stream via interface logic 515, stream receiving logic 510 may instruct the source device 210 associated with the selected stream to transmit a full bit rate stream. In this manner, processing load on host device 205 and bandwidth usage on network 215 may be limited.

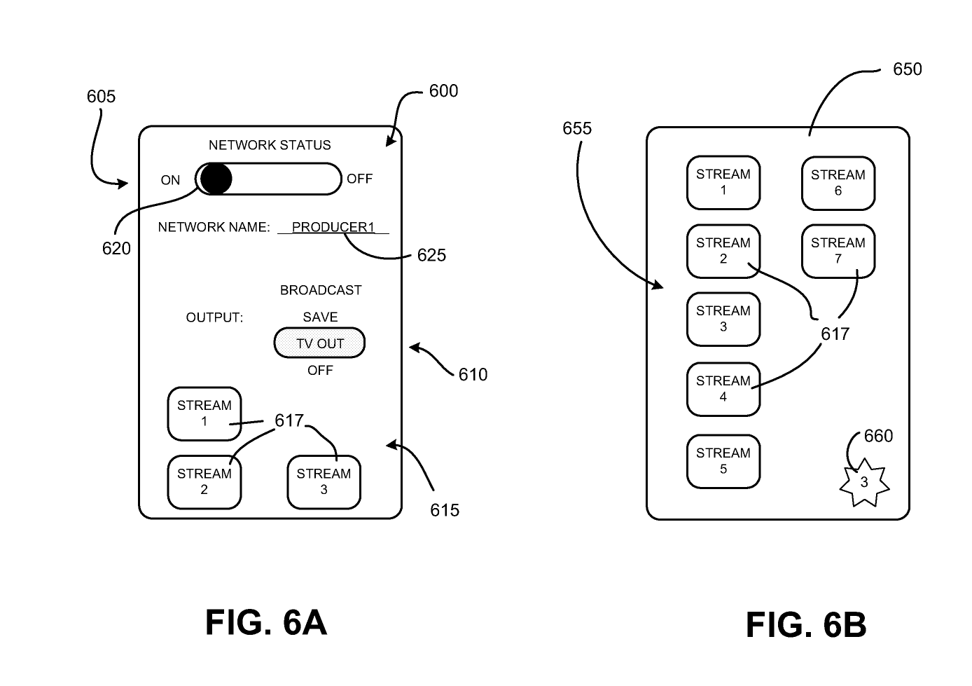

Interface logic 515 may include hardware and/or software components configured to display representations of the received media streams on a display 415 of host device 205. Interface logic 515 may be further configured to receive a user selection of a particular media stream for insertion into a broadcast or final output stream. In addition to media stream representations, interface logic 515 may be configured to display various session establishment and stream outputting configuration elements on display 415, such as a name of host device, options to start or stop broadcasting, and broadcast stream destination information. Details regarding the interfaces provided by interface logic 515 are set forth in additional detail below with respect to FIGS. 6A-6B.

Output configuration logic 520 may include hardware and/or software components configured to receive user selections of broadcast stream output destination options from interface logic 515. In response to these selections, stream outputting/storing logic 525 may be configured to transmit the selected media stream, in substantially real time, to the selected destination. Exemplary output destinations may include a storage device or medium, an external display device, such as a television, or a remote network device via, e.g., network 220 in FIG. 2.

FIGS. 6A-6B are diagrams of exemplary user interfaces associated with the host device of FIG. 5. FIG. 6A illustrates an exemplary user interface 600 displayed on display 415 of host device 205 upon opening of media stream production application 500. As illustrated in FIG. 6A, user interface 600 may include a session configuration/settings section 605, a broadcasting status section 610, and a media streams section 615.

Session configuration/settings section 605 may be configured to provide information and selectable interface elements relating to manner in which media streaming sessions with source devices 210 are established. For example, session configuration/settings section 605 may include a network activity selection element 620, and a network/host name identifier/selector 625. Network activity selection element 620 may include a power on/power off selector for enabling and disabling host device 205's ability to receive media streams from source devices 210. In some implementations, network activity selection element 620 may also include an selectable element that enables a user to select the type of network used to receive the media streams, such as an existing WLAN, an ad-hoc network, a 3G network, etc. Although not depicted in FIG. 6A, selection of an option in network activity selection element 620 may cause host device 205 to display additional settings associated with the selected option, such as a network selection option, a host name option, etc.

Network/host name identifier/selector 625 may include a selectable or editable identifier associated with host device 205. For example, network/host name identifier/selector 625 may include a name associated with host device 205 that is broadcast to source devices 210, e.g., via network 215. In the example of FIG. 6A, the network/host name is “Producer1.”

Broadcasting status section 610 may include an indicator representative of the status and destination of the live broadcast stream being output/recorded by host device 205. For example, broadcasting status section 610 may indicate that host device 205 is “Active” and outputting the live broadcast to an external “TV Out” display.

Media streams section 615 may include representations 617 associated with live media streams received from source devices 205. Exemplary representations 617 may include still images, low-resolution videos, user identifications associated with the device from which the streams are received, etc. As illustrated in FIG. 6A, media stream representations 617 may include thumbnail views of a number of available media streams. In some implementations, more media streams may be received by host device 205 than may be shown in media streams section 615. In this implementation, a selectable indication element, such as a “more streams” element (not shown in FIG. 6A) may be provided in media streams section 615. Selection of the “more streams” element (e.g., via touch or tapping of the element or selection via a control key 306) may cause interface logic 515 to display a user interface capable of showing more stream representations 617 than those shown in media streams section 615 of user interface 600.

FIG. 6B illustrates an exemplary user interface 650 displayed on display 415 of host device 205 upon selection of a “more streams” element. As illustrated, user interface 650 may include a grid-like arrangement 655 of stream representations 617. The size of stream representations 617 and/or the number of stream representations 617 displayed in grid-like arrangement 655 may be configured by the user of host device 205.

In other implementations, user interface 650 may display media stream representations 617 in other display arrangements. For example, representations 617 of available media streams may be arranged in a three-dimensional (3D) environment that may enable a user to flip through the representations 617. In another example, representations 617 may be overlaid on a map or floor plan of a venue, indicating a location of the source device 210 from which the stream is received.

In some implementations, as new streams are received at host device 205, representations 617 may be automatically inserted into grid-like arrangement 655 of user interface 650 or into media streams section 615 of user interface 650. In other implementations, an indication of the availability of new streams, such as a badge notification element, a textual indicator, an icon, etc. may be provided in user interface 600/650 to alert a user of host device 205 to the availability of the new media stream(s). For example, as illustrated in FIG. 6B, a selectable badge notification element 660 indicating a number of new media streams may be provided in user interface 650. Selection of badge notification element 660 may cause user interface 650 to refresh representations 617 to include the representations 617 corresponding to the new streams. In other implementations, or otherwise selection of badge notification element 660 may cause interface logic 515 to display a user interface dedicated to the newly available media streams.

As described above, interface logic 515 may be configured to receive a user selection of a particular media stream representation 617, displayed, for example, via user interface 600 or user interface 650. Upon selection of a particular media stream representation, stream outputting/storing logic 525 may, based on the output configuration information received in user interface 600, broadcast or otherwise transmit the selected stream to the selected output destination.

At this point, interface logic 515 may display a user interface similar to that described above in FIG. 1, depicting a currently selected/broadcast stream, a number of available stream representations, and output destination information. This may be referred to as a dashboard interface and may enable the user of host device 205 to easily determine the current status of media stream production application 500.

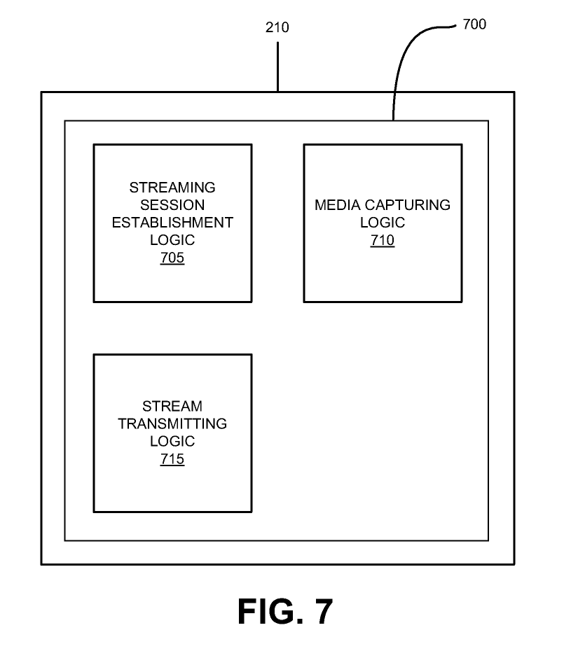

FIG. 7 is a functional block diagram of source device 210. As shown, source device 210 may include a media streaming application 700 that includes streaming session establishment logic 705, media capturing logic 710, and stream transmitting logic 715. Depending on the particular implementation, source device 210 may include fewer, additional, or different types of functional blocks than those illustrated in FIG. 7.

Streaming session establishment logic 705 may include hardware and/or software components configured to enable establishment of streaming sessions between source device 210 and host device 205, using, e.g., network interface 430. For example, streaming session establishment logic 505 may identify a host identifier on a WLAN indicating that host device 205 can receive a media stream from source device 210. In other implementations, such as where no WLAN previously exists, streaming session establishment logic 505 may, via network interface 430, identify and connect to an ad-hoc network generated by host device 205 to facilitate receipt of a media stream from source device 210.

As described above, in some implementations, host device 205 may broadcast the host identifier using, for example, bonjour or other zero-configuration protocol. Using such a protocol, streaming session establishment logic 705 may easily identify an available host device.

In still other implementations, streaming session establishment logic 705 may be configured to support establishment of a streaming session with host devices 205 via, e.g., a cellular communications network, such as a 3G network.

Streaming session establishment logic 705 of source device 210 may be further configured to transmit a session request to host device 205. The session request implementations may include information relating to the quality capabilities of source device 210, such as a resolution of a video camera, bandwidth capabilities, etc. This information may be used by host device 205. In some implementations consistent with embodiments described herein, streaming session establishment logic 705 may support authentication between source device 210 and host device 205. For example, users of source device 210 may need to enter a password prior to session establishment. Streaming session establishment logic 705 may be configured to establish a substantially real time streaming session with host devices 205.

Media capturing logic 710 may include hardware and/or software components configured to capture media from one or more input devices. For example, media capturing logic 710 may interface with lens assembly 312/316, and or microphone 310 to receive visual and/or audio information. In one implementation, a user of source device 210 may select a type of media for capturing by media capturing logic 710.

Stream transmitting logic 715 may include hardware and/or software components configured to receive the captured media from media capturing logic 710 and transmit the captured media via the streaming session established with host device 205. For example, stream transmitting logic 715 may transmit a 3GPP-compliant media stream via a media session 225. In some implementations, stream transmitting logic 715 may be configured to optimize the media stream based on capabilities and/or requirements of network 215 via which the streaming session has been established. For example, stream transmitting logic 715 may reduce a bit or data rate of the stream, reduce a resolution of a video or images transmitted via the stream, etc.

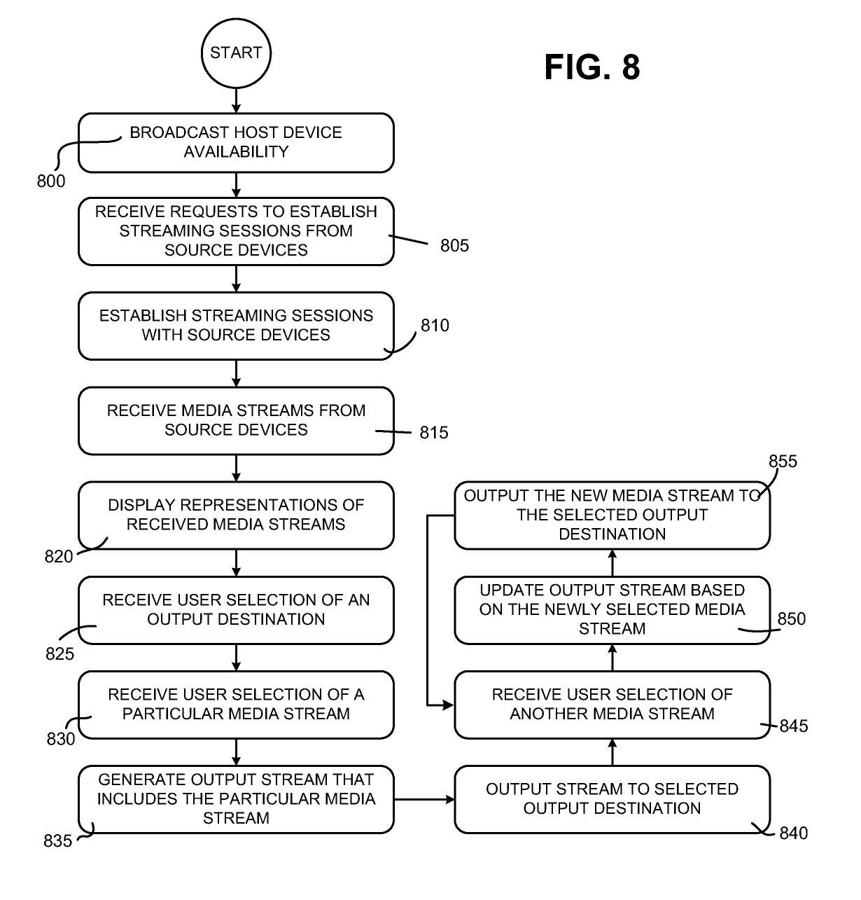

FIGS. 8 is a flow chart illustrating an exemplary process for enabling real time media stream selection and broadcasting consistent with implementations described herein. In some implementations, the process may be performed by media stream production application 500 in host device 205. In other instances, some or all of the described process may be performed by one or more components of source device 210, such as, for example, media streaming application 700.

As illustrated in FIG. 8, processing may begin with host device 205 broadcasting its availability to receive real time media streams from source devices 210 (block 800). For example, as described above, host device 205 may broadcast or otherwise output an indication/identifier indicative of the capabilities/status of host device 205. In other implementations, host device 205 may transmit a message to users of source devices 210 that includes information regarding the manner in which source device 210 may connect to host device 205 (e.g., a uniform resource locator (URL) associated with the host device, a username, secure link, etc.). In this way, an identity of the host device may be kept private from uninvited users.

Host device 205 may receive requests from source devices to establish real time streaming sessions with host device 205 (block 805). In one implementation, host device 205 may receive connection requests via WLAN or ad-hoc network 215. In other implementations, host device 205 may receive connection requests from source devices 210 via a network device, such as a server.

Streaming sessions may be established with a number of source devices 210 (block 810). For example, host device 205 may exchange configuration information with source devices 210 and may establish an RTP or RTSP-based sessions with source devices 210. Further, as mentioned above, in some implementations, host device 205 may enforce an authentication mechanism with each source device 210.

Host device 205 may receive real time media streams from source devices 210 via the established streaming sessions (block 815). For example, host device 205 may receive 3GPP-compliant media streams via the established RTSP-based sessions. In other implementations, any suitable media/streaming formats may be used.

Host device 205 may display representations associated with the received media streams to a user (block 820). For example, as described above, interface logic 515 may output user interface 600/650 that includes representations 617 corresponding to the received media streams. In some implementations, representations 617 may include graphical elements, such as still images, videos, etc. In other implementations, representations 617 may include textual descriptions of the received media streams, such as location identifiers, user identifiers, device names, etc.

Host device 205 may receive a user selection of an output destination for an output real time stream (block 825). For example, as described above, interface logic 515 may provide an interface that enables a user to select from among a number of output types, such as a broadcast via network upload, output to an external display device, or record to a storage device. Depending on the output destination type selection, interface logic 515 may further receive information relating to the selected destination, such URL/credentials associated with a network upload, a file path for a storage device, etc.

Host device 205 may receive a user selection of a particular media stream for inclusion in the output real time stream (block 830). As described above, interface logic 515 may allow host device 205 to view and select from the available media streams received from source devices 210. For example, interface logic 515 may provide an interface that allows a user to scroll or flip through representations 617 to select a particular stream for inclusion in the output real time stream. In some implementations, host device 205 may highlight or otherwise promote media streams meeting predefined criteria, such as quality, subject, etc.

Host device 205 may generate an output stream that includes the selected media stream (block 835) and may output the output stream to the selected output destination (block 840). The stream may be output in a manner consistent with the selected output destination. In some implementations, outputting of the output stream may require an affirmative selection by the user (e.g., selection of a “start” button or element). In other implementations, outputting of the output stream may be performed automatically upon selection of a media stream.

Host device 205 may receive a user selection of another particular media stream for inclusion in the output real time stream (block 845). For example, as described above, host device 205 may, during outputting of the output stream, continue to display representations of other media streams received from source devices 210. Host device may modify or update the output stream to include the new media stream (block 850) and may output the new media stream to the selected output destination (block 855). Processing may then return to block 845 where additional media stream selections may be made.

As an illustrative example, assume that source devices 210 are operating in a party environment where people are dancing and/or a musical act is performing (e.g., a wedding reception, etc.). Individual source devices 210 may establish streaming sessions with host device 205 and may transmit real time video streams from various locations in the party. Host device 205 may receive the real time video streams and may dynamically select individual video streams for inclusion in a final produced stream that is outputted to, for example, a projector display device at the party.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, while series of blocks have been described with regard to the exemplary processes illustrated in FIGS. 8, the order of the blocks may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method, comprising:
establishing, via a mobile device, a plurality of media streaming sessions with a respective plurality of source devices;
receiving, at the mobile device, a plurality of media streams from respective plurality of source devices;
displaying representations of the plurality of received media streams;
receiving a user selection of a particular one of the plurality of received media streams; and
outputting an output stream that includes the particular one of the plurality of received media streams.

2. The method of claim 1, wherein the plurality of source devices comprise mobile devices.

3. The method of claim 2, wherein the plurality of media streams and the output stream comprise substantially real time streams.

4. The method of claim 1, wherein establishing the plurality of media streaming sessions further comprises:
outputting a host identifier associated with the mobile device on a network connected to the source devices.

5. The method of claim 4, wherein the network comprises a wireless local area network (WLAN), an ad-hoc wireless network, or a cellular telecommunications network.

6. The method of claim 4, further comprising:
receiving a request to establish the streaming sessions from each of the plurality of source devices based on the host identifier.

7. The method of claim 1, wherein establishing the plurality of media streaming sessions further comprises:
transmitting, to each of the plurality of source devices, information relating to the streaming sessions, wherein the information comprises addressing information.

8. The method of claim 1, wherein establishing the plurality of media streaming sessions further comprises:
authenticating the plurality of source devices.

9. The method of claim 1, further comprising:
receiving, at the mobile device, a user selection of a destination for the output stream; and
outputting the output stream to the selected destination.

10. The method of claim 9, wherein the destination comprises an external display, a storage device, or a network device associated with a media streaming service.

11. The method of claim 10, wherein the external display comprises a television or video projector.

12. The method of claim 1, further comprising:
receiving a user selection of another particular one of the plurality of received media streams;
modifying the output stream to include the another particular one of the plurality of received media streams; and
outputting the modified output stream that includes the another particular one of the plurality of received media streams.

13. A mobile device comprising:
a network interface to receive a plurality of video streams from a respective plurality of source devices;
a display;
an output interface; and
a processor to:
establish a plurality of video streaming sessions with the respective plurality of source devices for enabling the network interface to receive the plurality of video streams;
display representations of the plurality of received video streams on the display;
receive a user selection of a particular one of the plurality of received video streams; and
output an output stream via the output interface, wherein the output stream includes the particular one of the plurality of received media streams.

14. The mobile device of claim 13, wherein the plurality of video streaming sessions comprise substantially real time streaming sessions for receiving substantially real time video streams from the plurality of source devices via the network interface.

15. The mobile device of claim 13, wherein the processor is further configured to:
output a host identifier associated with the mobile device to the plurality of source devices via the network interface.

16. The mobile device of claim 15, wherein the host identifier is output via a zero-configuration protocol.

17. The mobile device of claim 13, wherein the network interface is configured to receive the plurality of video streams via a wireless local area network (WLAN), an ad-hoc wireless network, or a cellular telecommunications network.

18. The mobile device of claim, wherein the processor is further configured to:
receive a user selection of a destination for the output stream; and
output the output stream to the selected destination via the output interface.

19. A computer-readable medium having stored thereon a plurality of sequences of instructions which, when executed by at least one processor, cause the at least one processor to:
receive a plurality of substantially real time media streams from a respective plurality of source devices;
display, to a user, representations of the plurality of received substantially real time media streams;
receive, from the user, a selection of a particular one of the plurality of received substantially real time media streams; and
output an output stream that includes the particular one of the plurality of received media streams.

20. The computer-readable medium of claim 19, wherein the plurality of sequences of instructions further cause the at least one processor to output the output stream to an external display device that includes a television, or a projector.
